(19) United States
(12) Patent Application Publication
(10) Pub. No.: US 2024/0257226 A1
(43) Pub. Date: Aug. 1, 2024

(54) MANAGEMENT SYSTEM FOR HOURLY RENTAL FACILITY

(71) Applicant: TAISHO SKY BUILDING, INC., Tokyo (JP)

(72) Inventor: Kazuharu Ishida, Tokyo (JP)

(21) Appl. No.: 18/633,480

(22) Filed: Apr. 11, 2024

Related U.S. Application Data
(63) Continuation of application No. PCT/JP21/37554, filed on Oct. 11, 2021.

(51) Int. Cl. G06Q 30/0645

(52) U.S. Cl. CPC G06Q 30/0645

(57) ABSTRACT

An on-demand rental facility management system includes a management server for managing a room. The management server includes a device operation unit for operating devices via a terminal device, and a reservation receiving unit for receiving a reservation for the room via the terminal device and storing reservation information in a storage unit. The device operation unit controls the devices after end of previous reservation and before start of the reservation date and time on the basis of operation information for operating the devices that is input via the terminal device and the reservation information.

### RELATED APPLICATIONS

The present application is a continuation of International Patent Application No. PCT/JP2021/037554, filed Oct. 11, 2021, which is hereby incorporated by reference in its entirety.

### TECHNICAL FIELD

The present disclosure relates to an on-demand rental facility management system.

### BACKGROUND

Rental facilities, such as conference rooms of a building, an office, a hotel, or the like, typically include a management server open to a communication network such as the Internet and a plurality of reservation servers in which information on the rental facility is stored. A user can access information on the rental facility in the reservation server via the management server to reserve a desired room. In addition, rental systems typically also have a billing function so that a rental fee can be paid online.

On-demand rental facilities typically include various devices, such as air conditioners, audio and video equipment, and lighting equipment. A user (e.g., a reservation person) of an on-demand rental facility may operate a remote control provided in the on-demand rental facility (e.g., to operate an air conditioner or audio and video equipment), or operate a switch provided in the on-demand rental facility (e.g., to operate lighting equipment), to set an environment of the on-demand rental facility according to one's preference.

However, since various devices cannot be controlled without operating individual operating means such as remote controls and switches, the environment of the on-demand rental facility cannot be set before the reservation date and time according to one's preference, thereby decreasing user convenience.

### SUMMARY

An object of the present disclosure is to provide an on-demand rental facility management system capable of setting an environment of an on-demand rental facility according to one's preference before the reservation date and time, thereby improving user convenience.

The on-demand rental facility management system according to the present disclosure is an on-demand rental facility management system including: an on-demand rental facility; and a management server that manages the on-demand rental facility and is connected via a communication line to both user input means that receives information input by a user of the on-demand rental facility and a device provided in the on-demand rental facility, in which the management server includes: a device operation unit for allowing the user to operate the device via the user input means; and a reservation receiving unit for storing reservation information on the user and reservation date and time of the on-demand rental facility in a storage unit by receiving a reservation for the on-demand rental facility via the user input means, and the device operation unit controls the device after end of previous reservation and before start of the reservation date and time on the basis of operation information for operating the device, that is input via the user input means, and the reservation information stored in the storage unit.

With such a configuration, the device operation unit controls the device after the end of the previous reservation and before the start of the reservation date and time on the basis of the operation information for operating the device, which is input via the user input means, and the reservation information stored in the storage unit. According to this, the user operates the device provided in the on-demand rental facility by the user input means before the start of the reservation date and time, so that the device operation unit can be controlled after the end of the previous reservation and before the start of the reservation date and time. Therefore, the user can set and prepare the environment of the on-demand rental facility according to one's preference, for example, by operating the air conditioner or the like before the start of the reservation date and time.

In the present disclosure, it is preferred that the management server includes an operation management unit that associates the user of the on-demand rental facility with the device operation unit to make user information, and stores and manages the user information in the storage unit, and stores setting information set in the device in advance via the device operation unit in the storage unit for each device operation unit, and the device operation unit operates the device after the end of the previous reservation and before the start of the reservation date and time on the basis of the setting information stored in the storage unit and the reservation information stored in the storage unit.

With such a configuration, since the management server includes the operation management unit that associates the user of the on-demand rental facility with the device operation unit to make the user information, and stores and manages the user information in the storage unit, the user can operate the device by a dedicated device operation unit. Further, the operation management unit stores setting information set in the device in advance via the device operation unit in the storage unit for each device operation unit, and the device operation unit operates the device after the end of the previous reservation and before the start of the reservation date and time on the basis of the setting information stored in the storage unit and the reservation information stored in the storage unit. According to this, by setting the setting information in the device in advance via the device operation unit, the user can set and prepare the environment of the on-demand rental facility according to one's preference by operating the device provided in the on-demand rental facility to a desired state, without inputting the operation information for operating the device via the device operation unit each time making a reservation.

In the present disclosure, it is preferred that the operation management unit stores in the storage unit, for each device operation unit, required/non-required information on whether or not the device is required, which is set in the device in advance via the device operation unit.

With such a configuration, the operation management unit stores in the storage unit, for each device operation unit, the required/non-required information on whether or not the device is required, which is set in the device in advance via the device operation unit. According to this, the user can manage whether or not the device is required by the dedicated device operation unit. In addition, by inputting the required/non-required information on whether or not the device is required in advance via the dedicated device operation unit, the user can set and prepare the environment of the on-demand rental facility according to one's preference by setting required/non-required of the device provided in the on-demand rental facility to a desired state, without inputting the required/non-required information on whether or not the device is required via the device operation unit each time making a reservation.

In the present disclosure, it is preferred that the management server includes an authorization unit for authorizing the user of the on-demand rental facility to operate the device at the reservation date and time via the device operation unit on the basis of the reservation information stored in the storage unit, and when authorized by the authorization unit, the device operation unit controls the device at the reservation date and time on the basis of the operation information for operating the device, that is input via the user input means, and the reservation information stored in the storage unit.

With such a configuration, the authorization unit authorizes the user of the on-demand rental facility to operate the device at the reservation date and time via the device operation unit on the basis of the reservation information stored in the storage unit, and when authorized by the authorization unit, the device operation unit controls the device at the reservation date and time on the basis of the operation information for operating the device, that is input via the user input means, and the reservation information stored in the storage unit. According to this, the user can operate the device provided in the on-demand rental facility, such as the air conditioner, the audio and video equipment, and the lighting equipment by the user input means. Therefore, the on-demand rental facility management system can share operating means for various devices provided in the on-demand rental facility, and improve the user convenience.

In the present disclosure, it is preferred that the on-demand rental facility includes display means that is provided in the on-demand rental facility and displays information, the management server includes a display control unit that causes the display means to switch and display predetermined information for each reservation for the on-demand rental facility, and when the user input means is caused to read the predetermined information displayed on the display means, the authorization unit authorizes the user of the on-demand rental facility to operate the device at the reservation date and time via the device operation unit.

With such a configuration, when the user input means is caused to read the predetermined information displayed on the display means, the authorization unit authorizes the user of the on-demand rental facility to operate the device at the reservation date and time via the device operation unit, so that the user can operate the device provided in the on-demand rental facility by the user input means by causing the user input means to read the predetermined information displayed on the display means. In addition, the display control unit causes the display means to switch and display the predetermined information for each reservation for the on-demand rental facility, so that a previous user cannot operate the device provided in the on-demand rental facility. Therefore, the on-demand rental facility management system can improve security of the on-demand rental facility.

In the present disclosure, it is preferred that the on-demand rental facility includes a locking device that locks and unlocks the on-demand rental facility, the management server includes an unlocking key issuing unit that issues an unlocking key for unlocking the locking device of the on-demand rental facility to the user on the basis of the reservation information stored in the storage unit, and when the locking device of the on-demand rental facility is unlocked by the unlocking key issued by the unlocking key issuing unit, the authorization unit authorizes the user of the on-demand rental facility to operate the device at the reservation date and time via the device operation unit.

With such a configuration, when the locking device of the on-demand rental facility is unlocked by the unlocking key issued by the unlocking key issuing unit, the authorization unit authorizes the user of the on-demand rental facility to operate the device at the reservation date and time via the device operation unit, so that the user can operate the device provided in the on-demand rental facility by the user input means by unlocking the locking device of the on-demand rental facility with the unlocking key. In addition, since the unlocking key issuing unit issues the unlocking key for unlocking the locking device of the on-demand rental facility to the user on the basis of the reservation information stored in the storage unit, other users cannot operate the device provided in the on-demand rental facility. Therefore, the on-demand rental facility management system can improve the security of the on-demand rental facility.

In the present disclosure, it is preferred that the management server includes an identification information issuing unit that issues predetermined identification information to the user on the basis of the reservation information stored in the storage unit, and when the identification information issued by the identification information issuing unit is received at the reservation date and time via the user input means, the authorization unit authorizes the user of the on-demand rental facility to operate the device at the reservation date and time via the device operation unit.

With such a configuration, when the identification information issued by the identification information issuing unit is received at the reservation date and time via the user input means, the authorization unit authorizes the user of the on-demand rental facility to operate the device at the reservation date and time via the device operation unit, so that the user can operate the device provided in the on-demand rental facility by the user input means by inputting the identification information via the user input means at the reservation date and time. In addition, since the identification information issuing unit issues the predetermined identification information to the user on the basis of the reservation information stored in the storage unit, other users cannot operate the device provided in the on-demand rental facility. Therefore, the on-demand rental facility management system can improve the security of the on-demand rental facility.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a schematic configuration diagram of an on-demand rental facility management system according to an embodiment of the present disclosure.

FIG. 2 is a functional block diagram illustrating a schematic configuration of the on-demand rental facility management system.

FIG. 3 is a diagram illustrating an operation panel displayed on a terminal device by a device operation unit.

FIG. 4 is a diagram illustrating an overview of setting information and required/non-required information stored in a storage unit.

FIG. 5 is a flowchart illustrating an operation of the on-demand rental facility management system.

FIG. 6 is a diagram illustrating the operation panel displayed on the terminal device after authorized by an authorization unit.

### DETAILED DESCRIPTION

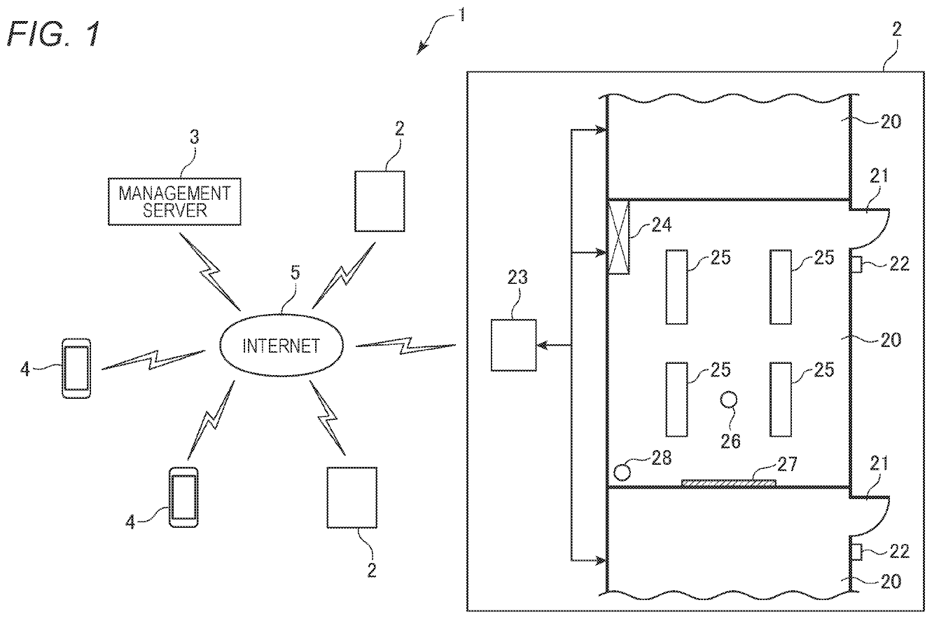

FIG. 1 is a schematic configuration diagram of an on-demand rental facility management system according to the embodiment of the present disclosure.

As illustrated in FIG. 1, an on-demand rental facility management system 1 includes a building 2 having a plurality of rooms 20 (rental spaces) as an on-demand rental facility, a management server 3 for managing the building 2, and a terminal device 4 such as a mobile phone, a smart phone, or a personal computer owned by a user wishing to use the building 2. The terminal device 4 functions as user input means that receives information input by the user of the on-demand rental facility. The building 2, the management server 3, and the terminal device 4 are connected to be able to communicate with each other via the Internet 5, which is a public network as a communication line.

Each room 20 includes a doorway 21 and a locking device 22 for locking and unlocking the doorway 21. The locking device 22 can be unlocked by an unlocking key such as a password or an optical code such as a bar code or a QR code (registered trademark) issued from the management server 3 to the terminal device 4 of the user. This unlocking key is randomly changed each time it is used, and the user who makes a reservation for that time can unlock the locking device 22 by using a unique unlocking key.

Note that in the present embodiment, the password, or the optical code such as the bar code or the QR code (registered trademark) is employed as the unlocking key, but for example, biometric authentication such as face authentication, fingerprint authentication, or retinal authentication may be employed, and any unlocking key may be employed as long as it can unlock the locking device 22.

Each room 20 includes a communication terminal device 23 such as a modem or router connected via a Local Area Network (LAN), devices 24 to 27 connected to the Internet 5 via the communication terminal device 23, and display means 28. In other words, the devices 24 to 27 and the display means 28 are connected to the management server 3 via the Internet 5.

The devices 24 to 27 and the display means 28 are so-called Internet of Things (IoT) devices, and by being connected to the Internet 5, they can transmit and receive various information to and from external devices including the management server 3. Therefore, the management server 3 can transmit a control command to the devices 24 to 27 and the display means 28 to control operation of the devices 24 to 27 and the display means 28, and receive information transmitted from the devices 24 to 27 and the display means 28.

Specifically, the device 24 is an air conditioner 24 provided on a wall surface of the room 20, the device 25 is a plurality of lighting devices 25 provided on a ceiling of the room 20, the device 26 is a projector 26 is provided on a floor surface of the room 20, and the device 27 is a screen 27 provided on the wall surface of the room 20. The display means 28 is a display that is provided in a corner of the room 20 and displays information.

Note that the devices may be IoT devices of a different type from the devices 24 to 27, and each room 20 may include furniture such as desks and chairs, or other devices such as a multifunction device and a whiteboard in addition to the IoT devices such as the devices 24 to 27.

The user can use the terminal device 4 to access the management server 3 via the Internet 5, search for a room 20 desired to be used, specify reservation date and time, and make a reservation for the room 20.

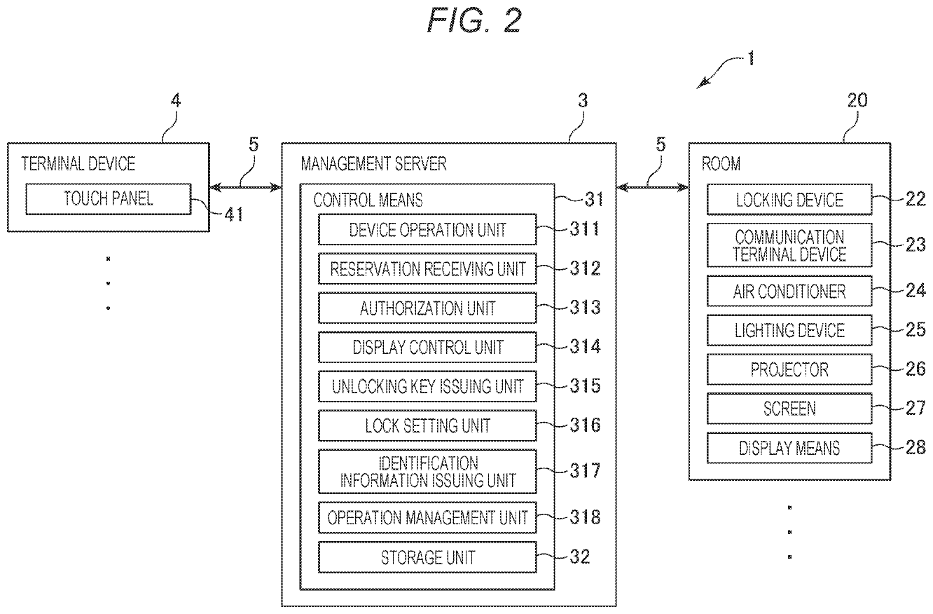

FIG. 2 is a functional block diagram illustrating a schematic configuration of the on-demand rental facility management system.

As illustrated in FIG. 2, the terminal device 4 includes a touch panel 41. The touch panel 41 receives input of information according to the user's operation, and provides information to the user in the form of an image.

The management server 3 includes control means 31, and the control means 31 includes a central processing unit (CPU), memory, and the like, and executes information processing according to a predetermined program stored in the memory. The control means 31 includes a device operation unit 311, a reservation receiving unit 312, an authorization unit 313, a display control unit 314, an unlocking key issuing unit 315, a lock setting unit 316, an identification information issuing unit 317, an operation management unit 318, and a storage unit 32.

Note that the storage unit 32 includes the memory of the control means 31, but may include a hard disk drive (HDD), a network attached storage (NAS), or the like, or may include a cloud service.

Further, functions of the control means 31 are performed according to the program stored in the storage unit 32, but may include independent devices, or may include cloud computing.

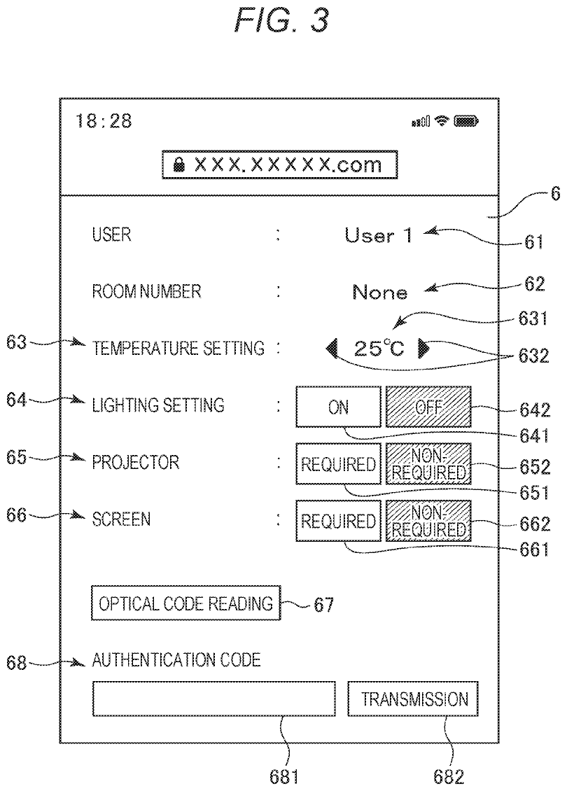

FIG. 3 is a diagram illustrating an operation panel displayed on the terminal device by the device operation unit.

The device operation unit 311 has a function for operating the devices 24 and 25 via the terminal device 4. Specifically, as illustrated in FIG. 3, the device operation unit 311 displays an operation panel 6 for operating the devices 24 and 25 on the touch panel 41 of the terminal device 4. Further, the device operation unit 311 controls the devices 24 and 25 on the basis of operation information for operating the devices 24 and 25, that is input to the operation panel 6 via the touch panel 41 of the terminal device 4.

The operation panel 6 includes a user information field 61 arranged at the top of the screen, a room information field 62 arranged below the user information field 61, a temperature setting field 63 arranged below the room information field 62, a lighting setting field 64 arranged below the temperature setting field 63, a projector setting field 65 arranged below the lighting setting field 64, a screen setting field 66 arranged below the projector setting field 65, a read button 67 arranged below the screen setting field 66, and an authentication code transmission field 68 arranged at the bottom of the screen.

The user can access the management server 3 via the Internet 5 using the terminal device 4 and enter a user name and password to log into the management server 3, and display the dedicated operation panel 6 on the touch panel 41 of the terminal device 4.

The user information field 61 is a field for displaying information of the user who has logged into the management server 3 and displayed the dedicated operation panel 6 on the touch panel 41 of the terminal device 4. In the present embodiment, since the user logs into the management server 3 with an account name “User 1”, the user information field 61 displays “User 1” as the user name.

The room information field 62 is a field for displaying information on the authorized room 20 when the user is authorized to operate the devices 24 and 25 at the reservation date and time via the operation panel 6. In the present embodiment, since the user has not yet been authorized to operate the devices 24 and 25 at the reservation date and time via the operation panel 6, the room information field 62 displays “None” as a room number.

The temperature setting field 63 is a field for setting temperature of the air conditioner 24. Specifically, the temperature setting field 63 includes a temperature display section 631 for displaying set temperature of the air conditioner 24 and a temperature change button 632 for raising or lowering the set temperature of the air conditioner 24. In the present embodiment, since the user sets the set temperature of the air conditioner 24 to “25° C.”, the temperature display section 631 displays “25° C.” as the set temperature. Further, the user can change to lower the set temperature of the air conditioner 24 by pressing the temperature change button 632 on the left side of the screen, and change to raise the set temperature of the air conditioner 24 by pressing the temperature change button 632 on the right side of the screen. In other words, the temperature change button 632 is a button for inputting operation information for operating the air conditioner 24.

The lighting setting field 64 is a field for setting on and off settings of the lighting devices 25. Specifically, the lighting setting field 64 includes an ON button 641 for turning on the lighting devices 25 and an OFF button 642 for turning off the lighting devices 25. In the present embodiment, since the user turns on the lighting devices 25, the lighting setting field 64 has the ON button 641 in a selected state and the OFF button 642 in an unselected state. Further, the user can change to turn on the lighting devices 25 by pressing the ON button 641, and can change to turn off the lighting devices 25 by pressing the OFF button 642. In other words, the ON button 641 and the OFF button 642 are buttons for inputting operation information for operating the lighting devices 25.

The projector setting field 65 is a field for setting whether or not the projector 26 is required. Specifically, the projector setting field 65 includes a required button 651 indicating that the projector 26 is required and a non-required button 652 indicating that the projector 26 is not required. In the present embodiment, since the user needs the projector 26, the projector setting field 65 has the required button 651 in a selected state and the non-required button 652 in an unselected state. Further, the user can change the projector 26 to be required by pressing the required button 651, and change the projector 26 to be not required by pressing the non-required button 652.

A screen setting field 66 is a field for setting whether or not the screen 27 is required. Specifically, the screen setting field 66 has a required button 661 indicating that the screen 27 is required and a non-required button 662 indicating that the screen 27 is not required. In the present embodiment, since the user needs the screen 27, the screen setting field 66 has the required button 661 in a selected state and the non-required button 662 in an unselected state. Further, the user can change the screen 27 to be required by pressing the required button 661, and change the screen 27 to be not required by pressing the non-required button 662.

The read button 67 is a button that causes the terminal device 4 to read the optical code displayed on the display means 28 in order to authorize the user to operate the devices 24 and 25 at the reservation date and time via the operation panel 6. In the present embodiment, the user can activate a camera of the terminal device 4 by pressing the read button 67, cause the terminal device 4 to read the optical code displayed on the display means 28, and transmit the optical code to the management server 3.

The authentication code transmission field 68 is a field for transmitting an authentication code issued to the user to the management server 3 in order to authorize the user to operate the devices 24 and 25 at the reservation date and time via the operation panel 6. Specifically, the authentication code transmission field 68 includes an authentication code input section 681 for inputting the authentication code, and a transmission button 682 for transmitting the authentication code input to the authentication code input section 681 to the management server 3. In the present embodiment, the user can input the authentication code into the authentication code input section 681 and press the transmission button 682, to transmit the authentication code to the management server 3.

As illustrated in FIG. 2, the reservation receiving unit 312 stores reservation information on the user of the room 20 and the reservation date and time (usage start time and usage end time) set by the reservation in the storage unit 32 by receiving a reservation for the room 20 via the terminal device 4.

The authorization unit 313 authorizes the user of the room 20 to operate the devices 24 and 25 at the reservation date and time via the device operation unit 311 on the basis of the reservation information stored in the storage unit 32.

Then, when authorized by the authorization unit 313, the device operation unit 311 controls the devices 24 and 25 on the basis of the operation information for operating the devices 24 and 25, that is input via the operation panel 6, and the reservation information stored in the storage unit 32.

Specifically, when the user presses the temperature change button 632 on the left side of the screen on the operation panel 6, the change can be immediately reflected to lower the set temperature of the air conditioner 24, and when the user presses the temperature change button 632 on the right side of the screen, the change can be immediately reflected to raise the set temperature of the air conditioner 24.

Further, when the user presses the ON button 641 on the operation panel 6, the change can be immediately reflected to turn on the lighting devices 25, and when the user presses the OFF button 642, the change can be immediately reflected to turn off the lighting devices 25.

Further, when authorized by the authorization unit 313, the device operation unit 311 controls the devices 24 and 25 after the end of the previous reservation and before the start of the reservation date and time on the basis of the operation information for operating the devices 24 and 25, that is input via the operation panel 6, and the reservation information stored in the storage unit 32.

Specifically, when the user presses the temperature change button 632 on the left side of the screen on the operation panel 6, the user can change to lower the set temperature of the air conditioner 24, and when the user presses the temperature change button 632 on the right side of the screen, the user can change to raise the set temperature of the air conditioner 24. Then, these changes will be reflected in the air conditioner 24 after the end of the previous reservation and before the start of the reservation date and time.

Further, when the user presses the ON button 641 on the operation panel 6, the lighting devices 25 can be changed to be turned on, and when the OFF button 642 is pressed, the lighting devices 25 can be changed to be turned off. Then, these changes will be reflected in the lighting devices 25 after the end of the previous reservation and before the start of the reservation date and time.

Note that, as timing for reflecting these changes in the air conditioner 24, for example, appropriate timing can be employed so that the set temperature is reached before the start of the reservation date and time, and as timing for reflecting these changes in the lighting devices 25, for example, appropriate timing such as 5 minutes before the usage start time can be employed. In short, the timing for reflecting these changes in the devices can be appropriately defined according to the type of devices or the like.

The display control unit 314 causes the display means 28 to switch and display the optical code (predetermined information) for each reservation for the room 20.

Then, when the optical code displayed on the display means 28 is read by the terminal device 4, the authorization unit 313 authorize the user of the room 20 to operate the devices 24 and 25 at the reservation date and time via the operation panel 6. In other words, the user can activate the camera of the terminal device 4 by pressing the read button 67, and when the optical code displayed on the display means 28 is read by the terminal device 4 and transmitted to the management server 3, the authorization unit 313 can be caused to authorize the user to operate the devices 24 and 25 at the reservation date and time via the operation panel 6.

The unlocking key issuing unit 315 issues the unlocking key for unlocking the locking device 22 of the room 20 on the basis of the reservation information stored in the storage unit 32.

Then, when the locking device 22 of the room 20 is unlocked by the unlocking key issued by the unlocking key issuing unit 315, the authorization unit 313 authorize the user of the room 20 to operate the devices 24 and 25 at the reservation date and time via the operation panel 6. In other words, when the locking device 22 of the room 20 is unlocked by the unlocking key issued by the unlocking key issuing unit 315, the authorization unit 313 can be caused to authorize the user to operate the devices 24 and 25 at the reservation date and time via the operation panel 6.

The lock setting unit 316 sets the locking device 22 of the room 20.

Specifically, when the usage start time included in the reservation information is reached (or it may be shortly before the usage start time (for example, 10 minutes before the usage start time)), the lock setting unit 316 sets the unlocking key corresponding to the reservation information to the locking device 22 of the room 20.

Further, when the usage end time included in the reservation information has passed (or it may be shortly after the usage end time (for example, 10 minutes after the usage end time)), the lock setting unit 316 resets an unlocking key different from the unlocking key corresponding to the reservation information in the locking device 22 of the room 20.

The identification information issuing unit 317 issues the authentication code (predetermined identification information) to the user on the basis of the reservation information stored in the storage unit 32.

Then, when the authentication code issued by the identification information issuing unit 317 is received via the operation panel 6 at the reservation date and time, the authorization unit 313 authorizes the user of the room 20 to operate the devices 24 and 25 at the reservation date and time via the operation panel 6. In other words, when the user inputs the authentication code into the authentication code input section 681 and presses the transmission button 682 to transmit the authentication code to the management server 3, the authorization unit 313 can be caused to authorize the user to operate the devices 24 and 25 at the reservation date and time via the operation panel 6.

The operation management unit 318 associates the user of the room 20 with the operation panel 6 to make user information, and stores and manages the user information in the storage unit 32, and stores setting information set in the devices 24 and 25 in advance via the operation panel 6 for each operation panel 6 in the storage unit 32.

In addition, the operation management unit 318 stores, for each operation panel 6, in the storage unit 32 required/non-required information on whether or not the devices 26 and 27 are required, which is set in the devices 26 and 27 in advance via the operation panel 6.

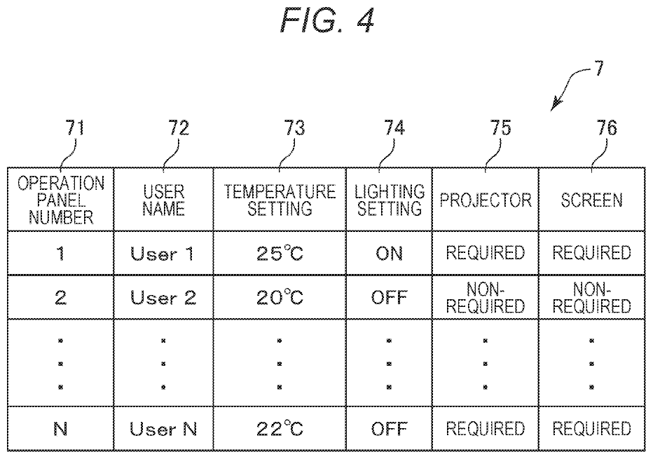

FIG. 4 is a diagram illustrating an overview of the setting information and the required/non-required information stored in the storage unit.

The operation management unit 318 stores the user information, the setting information, and the required/non-required information for each operation panel 6 in the storage unit 32 and manages them as a database.

Specifically, the operation management unit 318 manages a database 7 as illustrated in FIG. 4. The database 7 includes a plurality of data columns of an operation panel number column 71, a user name column 72, a temperature setting column 73, a lighting setting column 74, a projector required/non-required column 75, and a screen required/non-required column 76.

The operation panel number column 71 is a data column in which unique operation panel numbers (1 to N) are respectively assigned for operation panels 6.

The user name column 72 is a data column that stores account names (User 1 to User N) of users of the room 20 associated with the operation panels 6 corresponding to the operation panel numbers in the operation panel number column 71.

Thus, the operation panel number column 71 and the user name column 72 function as the user information that associates the users of the room 20 with the operation panels 6.

The temperature setting column 73 is a data column that stores the set temperature of the air conditioner 24 set in the operation panel 6 corresponding to the operation panel number in the operation panel number column 71.

The lighting setting column 74 is a data column that stores the on and off settings of the lighting devices 25 set in the operation panel 6 corresponding to the operation panel number in the operation panel number column 71.

Thus, the temperature setting column 73 and the lighting setting column 74 function as the setting information set in the devices 24 and 25 in advance via the operation panel 6.

In the present embodiment, for example, the user (User 1) associated with the operation panel 6 having an operation panel number “1” sets the temperature setting of the air conditioner 24 to “25° C.” and sets the on and off settings of the lighting devices 25 to “ON”. Further, for example, the user (User 2) associated with the operation panel 6 having an operation panel number “2” sets the temperature setting of the air conditioner 24 to “20° C.” and sets the on and off settings of the lighting devices 25 to “OFF”.

The projector required/non-required column 75 is a data column that stores whether or not the projector 26 set in the operation panel 6 corresponding to the operation panel number in the operation panel number column 71 is required.

The screen required/non-required column 76 is a data column that stores whether or not the screen 27 set in the operation panel 6 corresponding to the operation panel number in the operation panel number column 71 is required.

Thus, the projector required/non-required column 75 and the screen required/non-required column 76 function as the required/non-required information on whether or not the devices 26 and 27 is required, which is set in the devices 26 and 27 in advance via the operation panel 6.

In the present embodiment, for example, the user (User 1) associated with the operation panel 6 having the operation panel number “1” sets required/non-required of the projector 26 to “required” and sets required/non-required of the screen 27 to “required”. Further, for example, the user (User 2) associated with the operation panel 6 having the operation panel number “2” sets the required/non-required of the projector 26 to “non-required” and sets the required/non-required of the screen 27 to “non-required”.

Here, the user accesses the management server 3 via the Internet 5 using the terminal device 4 and inputs the user name and password, to log into the management server 3 and display the dedicated operation panel 6 on the touch panel 41 of the device 4, and when the devices 24 to 27 are operated by the operation panel 6, the user information, the setting information, and the required/non-required information can be stored in the database 7 in the storage unit 32 for each operation panel 6. In other words, the user can store the latest history of operation information for operating the devices 24 and 25, that is input via the operation panel 6, in the database 7 in the storage unit 32 as the setting information.

Note that in the present embodiment, the operation management unit 318 stores the setting information and the required/non-required information in the database 7 in the storage unit 32 each time operation of the operation panel 6 by the user is received, but for example, a save button or the like may be provided on the operation panel 6, and the setting information and the required/non-required information may be stored in the database 7 in the storage unit 32 when the save button is pressed.

Then, when authorized by the authorization unit 313, the device operation unit 311 is configured to operate the devices 24 and 25 after the end of the previous reservation and before the start of the reservation date and time on the basis of the setting information stored in the storage unit 32 and the reservation information stored in the storage unit 32. In other words, when the setting information is stored in the database 7, by specifying the reservation date and time and making the reservation for the room 20, the user can reflect the set temperature of the air conditioner 24 and the on and off settings of the lighting devices 25 on the basis of the setting information stored in the storage unit 32, without operating the devices 24 and 25 again by the operation panel 6.

Note that, as timing for reflecting the set temperature in the air conditioner 24, for example, appropriate timing can be employed so that the set temperature is reached before the start of the reservation date and time, and as timing for reflecting the on and off settings in the lighting devices 25, for example, the appropriate timing such as 5 minutes before the usage start time can be employed. In short, the timing for reflecting these pieces of setting information in the devices can be appropriately defined according to the type of devices or the like.

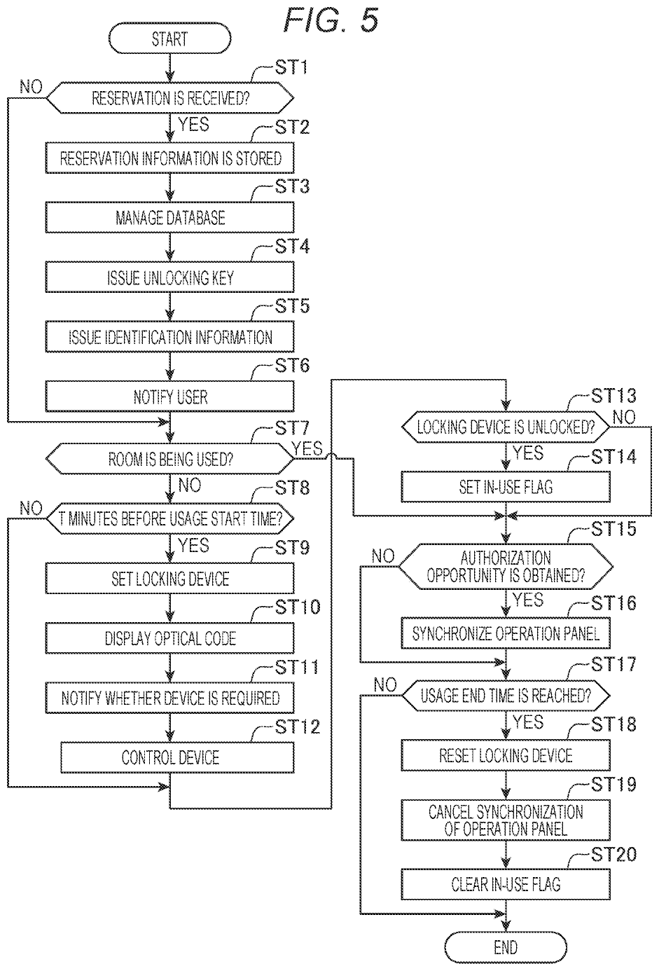

FIG. 5 is a flowchart illustrating an operation of the on-demand rental facility management system.

As illustrated in FIG. 5, the control means 31 of the management server 3 repeatedly executes various processing of steps ST1 to ST20 at predetermined time intervals according to the predetermined program stored in the memory.

As described above, the user of the room 20 can access the management server 3 via the Internet 5 using the terminal device 4, search for the room 20 desired to be used, specify a usage time, and make the reservation for the room 20.

The reservation receiving unit 312 determines whether the reservation for the room 20 is received via the terminal device 4 in step ST1.

If it is determined that the reservation for the room 20 is not received, the control means 31 executes processing from step ST7 onward.

On the other hand, if it is determined that the reservation for the room 20 is received, in step ST2, the reservation receiving unit 312 stores the reservation information on the user of the room 20 and the reservation date and time (usage start time and usage end time) set by the reservation in the storage unit 32.

After executing the processing of step ST2, the operation management unit 318 stores the user information, the setting information, and the required/non-required information for each operation panel 6 in the storage unit 32 and manages them as the database 7 in step ST3.

In this way, the operation management unit 318 inputs initial values to the setting information and the required/non-required information and stores them in the database 7 at the time of first use. Thereafter, the operation management unit 318 stores the setting information and the required/non-required information in the database 7 in the storage unit 32 each time the operation of the operation panel 6 by the user is received.

Note that in the present embodiment, as the initial values, the set temperature of the air conditioner 24 is set to “25° C.”, the on and off settings of the lighting devices 25 is set to “ON”, the required/non-required of the projector 26 is set to “required”, and the required/non-required of the screen 27 is set to “required”.

After executing the processing of step ST3, in step ST4, the unlocking key issuing unit 315 issues the unlocking key for unlocking the locking device 22 of the room 20 to the user on the basis of the reservation information stored in the storage unit 32.

After executing the processing of step ST4, in step ST5, the identification information issuing unit 317 issues the authentication code (predetermined identification information) to the user on the basis of the reservation information stored in the storage unit 32.

After executing the processing of step ST5, in step ST6, the control means 31 notifies the user of information for using the dedicated operation panel 6 managed by the operation management unit 318 on the terminal device 4, the unlocking key issued by the unlocking key issuing unit 315, and the authentication code issued by the identification information issuing unit 317 by e-mail or the like.

After executing the processing of step ST6, or when it is determined that the reservation for the room 20 is not received in step ST1, the control means 31 determines whether the room 20 is being used in step ST7. Here, the control means 31 determines whether the room 20 is being used by referring to an in-use flag stored in the storage unit 32.

Note that the control means 31 sets the in-use flag in the storage unit 32 when the locking device 22 is unlocked, and clears the in-use flag from the storage unit 32 when the usage end time is reached.

If it is determined in step ST7 that the room 20 is being used, the control means 31 executes the processing from step ST15 onward.

On the other hand, if it is determined in step ST7 that the room 20 is not being used, in step ST8, the control means 31 determines whether it is T minutes before the usage start time of the room 20 included in the reservation information stored in the storage unit 32. In the present embodiment, T minutes before is set to 10 minutes before, but may be set to any number of minutes before the usage start time.

If it is determined in step ST8 that it is not T minutes before the usage start time of the room 20 (if it is determined that T minutes before the usage start time has passed), the control means 31 executes the processing from step ST13 onward.

On the other hand, if it is determined in step ST8 that it is T minutes before the usage start time of the room 20, in step ST9, the lock setting unit 316 sets the unlocking key corresponding to the reservation information to the locking device 22 of the room 20. Thus, the user can enter the room 20 by unlocking the locking device 22 of the room 20 using the unlocking key transmitted from the management server 3.

After executing the processing of step ST9, in step ST10, the display control unit 314 causes the display means 28 to display the optical code (predetermined information). In this manner, the display control unit 314 causes the display means 28 to switch and display the optical code for each reservation for the room 20.

After executing the processing of step ST10, the control means 31, in step ST11, the control means 31 notifies an administrator of the management system 1 of the on-demand rental facility whether the devices 26 and 27 are required on the basis of the required/non-required information in the database 7 managed by the operation management unit 318.

Then, the administrator of the on-demand rental facility management system 1 provides or removes the devices 26 and 27 in the room 20 to reflect the required/non-required of the devices 26 and 27 on the basis of the required/non-required of the devices 26 and 27 notified in step ST11.

Note that in the present embodiment, the devices 26 and 27 are manually provided or removed in the room 20 by the administrator of the on-demand rental facility management system 1 to reflect the required/non-required of the devices 26 and 27, but the on-demand rental facility management system may include transportation means for automatically transporting the devices, and by using the transportation means, the devices may be provided or removed in the on-demand rental facility to reflect the required/non-required of the devices.

After executing the processing of step ST11, in step ST12, the device operation unit 311 controls the devices 24 and 25 after the end of the previous reservation and before the start of the reservation date and time on the basis of the operation information for operating the devices 24 and 25, that is input via the operation panel 6, or the setting information stored in the storage unit 32, and the reservation information stored in the storage unit 32. In other words, when not authorized by the authorization unit 313, the device operation unit 311 controls the devices 24 and 25 after the end of the previous reservation and before the start of the reservation date and time on the basis of the operation information or the setting information and the reservation information.

Note that when the operation information and the setting information are different from each other, the device operation unit 311 controls the devices 24 and 25 on the basis of the operation information. In other words, the operation information is information having a higher priority than the setting information.

For example, the user (User 1) associated with the operation panel 6 having the operation panel number “1” sets the temperature setting of the air conditioner 24 to “25° C.” and sets the on and off settings of the lighting devices 25 to “ON” (see FIGS. 3 and 4).

Therefore, in step ST12, after the end of the previous reservation and before the start of the reservation date and time, the device operation unit 311 controls the set temperature of the air conditioner 24 to be “25° C.” and controls the on and off settings of the lighting devices 25 to be “ON” on the basis of the operation information for operating the devices 24 and 25, that is input via the operation panel 6, or the setting information stored in the storage unit 32, and the reservation information stored in the storage unit 32.

After executing the processing of step ST12, or if it is determined in step ST8 that it is not T minutes before the usage start time of the room 20 (if it is determined that T minutes before the usage start time has passed), the control means 31 determines whether the locking device 22 is unlocked in step ST13.

If it is determined that the locking device 22 is unlocked in step ST13, the control means 31 sets the in-use flag in the storage unit 32 in step ST14.

After executing the processing of step ST14, if it is determined in step ST7 that the room 20 is being used, or if it is determined in step ST13 that the locking device 22 is not unlocked, in step ST15, the authorization unit 313 determines whether an opportunity is obtained to authorize the user of the room 20 to operate the devices 24 and 25 at the reservation date and time via the operation panel 6.

Specifically, the authorization unit 313 obtains as the opportunity that the optical code displayed on the display means 28 is read by the terminal device 4. Further, the authorization unit 313 obtains as the opportunity that the locking device 22 of the room 20 is unlocked by the unlocking key issued by the unlocking key issuing unit 315. Furthermore, the authorization unit 313 obtains as the opportunity that the authentication code issued by the identification information issuing unit 317 is received via the operation panel 6 at the reservation date and time.

In the present embodiment, since the authorization unit 313 obtains as the opportunity that the locking device 22 of the room 20 is unlocked by the unlocking key issued by the unlocking key issuing unit 315, the user can be authorized without reading the optical code or transmitting the authentication code. However, in the present embodiment, since the authorization unit 313 uses reading of the optical code or transmission of the authentication code as the opportunity to authorize the user of the room 20 to operate the devices 24 and 25 at the reservation date and time via the operation panel 6, the user of the room 20 can be authorized even if it is a room that cannot be unlocked by the unlocking key issued by the unlocking key issuing unit 315 (for example, a room having a locking device that is unlocked using a physical key instead of the unlocking key).

If it is determined in step ST15 that the opportunity is obtained to authorize the user of the room 20 to operate the devices 24 and 25 at the reservation date and time via the operation panel 6, in step ST16, the authorization unit 313 authorizes the user of the room 20 to operate the devices 24 and 25 at the reservation date and time via the operation panel 6 on the basis of the reservation information stored in the storage unit 32.

Then, if authorized by the authorization unit 313, the device operation unit 311 synchronizes the operation panel 6 and the devices 24 and 25. In other words, if authorized by the authorization unit 313, the device operation unit 311 controls the devices 24 and 25 at the reservation date and time on the basis of the operation information for operating the devices 24 and 25, that is input via the operation panel 6, and the reservation information stored in the storage unit 32.

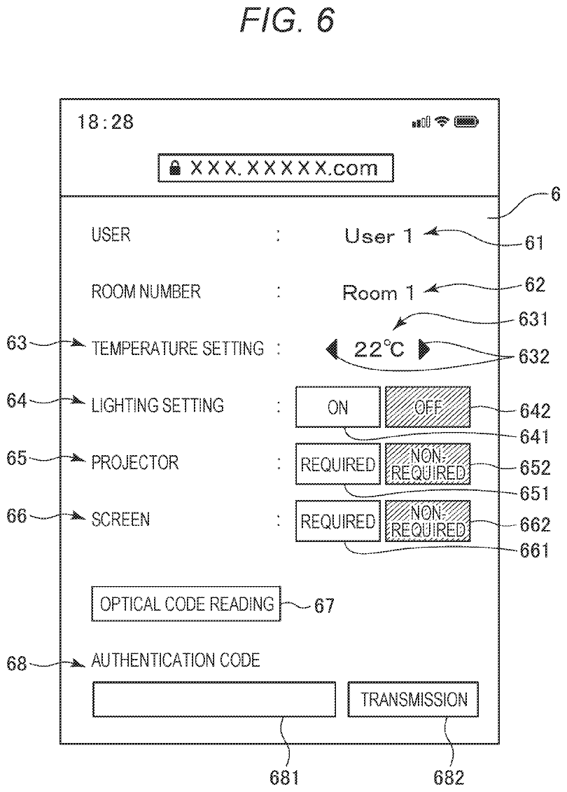

FIG. 6 is a diagram illustrating the operation panel displayed on the terminal device after authorized by the authorization unit.

After synchronizing the operation panel 6 and the devices 24 and 25, the device operation unit 311 displays the information of the room 20 which is authorized by the authorization unit 313 in the room information field 62 of the operation panel 6. For example, when the user is authorized to use “Room 1” reserved by the user, as illustrated in FIG. 6, the device operation unit 311 displays “Room 1” as the room number in the room information field 62.

Then, after the operation panel 6 and the devices 24 and 25 are synchronized by the device operation unit 311, when the user presses the temperature change button 632 on the left side of the screen on the operation panel 6, the change can be immediately reflected to lower the set temperature of the air conditioner 24, and when the user presses the temperature change button 632 on the right side of the screen, the change can be immediately reflected to raise the set temperature of the air conditioner 24. For example, the user can press the temperature change button 632 on the left side of the screen on the operation panel 6 to immediately lower the set temperature of the air conditioner 24 to “22° C.”.

After executing the processing of step ST16, or if it is determined in step ST15 that the opportunity is not obtained to authorize the user of the room 20 to operate the devices 24 and 25 at the reservation date and time via the operation panel 6, in step ST17, the control means 31 determines whether the usage end time of the room 20 included in the reservation information stored in the storage section 32 is reached, as illustrated in FIG. 5.

If it is determined in step ST17 that the usage end time of the room 20 is not reached, the control means 31 ends various processing without executing the processing from step ST18 onward.

On the other hand, if it is determined in step ST17 that the usage end time of the room 20 is reached, in step ST18, the lock setting unit 316 resets an unlocking key different from the unlocking key corresponding to the reservation information stored in the storage unit 32 in the locking device 22 of the room 20. This prevents the user from re-entering the room 20.

After executing the processing of step ST18, in step ST19, the device operation unit 311 cancels synchronization between the operation panel 6 and the devices 24 and 25. In other words, the device operation unit 311 revokes authorization granted by authorization unit 313.

After executing the processing of step ST19, in step ST20, the control means 31 clears the in-use flag from the storage unit 32.

After executing the processing of step ST20, the control means 31 ends various processing.

According to the present embodiment, the following functions and effects can be obtained.

(1) The authorization unit 313 authorizes the user of the room 20 to operate the devices 24 and 25 at the reservation date and time via the operation panel 6 on the basis of the reservation information stored in the storage unit 32, and when authorized by the authorization unit 313, the device operation unit 311 controls the devices 24 and 25 at the reservation date and time on the basis of the operation information for operating the devices 24 and 25, that is input via the terminal device 4, and the reservation information stored in the storage unit 32. According to this, the user can operate the devices 24 and 25 provided in the room 20 by the terminal device 4. Therefore, the on-demand rental facility management system 1 can share operating means for the various devices 24 and 25 provided in the room 20, and can improve user convenience.

(2) When the optical code displayed on the display means 28 is read by the terminal device 4, the authorization unit 313 authorizes the user of the room 20 to operate the devices 24 and 25 at the reservation date and time via the operation panel 6, so that the user can operate the devices 24 and 25 provided in the room 20 by the terminal device 4 by causing the terminal device 4 to read the optical code displayed on the display means 28. Further, since the display control unit 314 causes the display means 28 to switch and display the optical code for each reservation for the room 20, a previous user cannot operate the devices 24 and 25 provided in the room 20. Therefore, the on-demand rental facility management system 1 can improve the security of the room 20.

(3) When the locking device 22 of the room 20 is unlocked by the unlocking key issued by the unlocking key issuing unit 315, the authorization unit 313 authorizes the user of the room 20 to operate the devices 24 and 25 at the reservation date and time via the operation panel 6, so that the user can operate the devices 24 and 25 provided in the room 20 by the terminal device 4 by unlocking the locking device 22 of the room 20 by the unlocking key. Further, since the unlocking key issuing unit 315 issues the unlocking key for unlocking the locking device 22 of the room 20 to the user on the basis of the reservation information stored in the storage unit 32, other users cannot operate the devices 24 and 25 provided in the room 20. Therefore, the on-demand rental facility management system 1 can improve the security of the room 20.

(4) When the authentication code issued by the identification information issuing unit 317 is received via the terminal device 4 at the reservation date and time, the authorization unit 313 authorizes the user of the room 20 to operate the devices 24 and 25 at the reservation date and time via the operation panel 6, so that the user can operate the devices 24 and 25 provided in the room 20 by the terminal device 4 by inputting the authentication code by the terminal device 4 at the reservation date and time. Further, since the identification information issuing unit 317 issues the authentication code to the user on the basis of the reservation information stored in the storage unit 32, other users cannot operate the devices 24 and 25 provided in the room 20. Therefore, the on-demand rental facility management system 1 can improve the security of the room 20.

(5) The device operation unit 311 controls the devices 24 and 25 after the end of the previous reservation and before the start of the reservation date and time on the basis of the operation information for operating the devices 24 and 25, that is input via the terminal device 4, and the reservation information stored in the storage unit 32. According to this, the user operates the devices 24 and 25 provided in the room 20 by the terminal device 4 before the start of the reservation date and time, so that the user can cause the device operation unit 311 to control the devices 24 and 25 after the end of the previous reservation and before the start of the reservation date and time. Therefore, for example, the user can set and prepare the environment of the room 20 according to one's preference, for example, by operating the air conditioner 24 or the like before the start of the reservation date and time.

(6) Since the management server 3 includes the operation management unit 318 that associates the user of the room 20 with the operation panel 6 to make the user information, and stores and manages the user information in the storage unit 32, the user can operate the devices 24, 25 by the dedicated operation panel 6.

(7) The operation management unit 318 stores in the storage unit 32, for each operation panel 6, the setting information set in the devices 24 and 25 in advance via the operation panel 6, and the device operation unit 311 operates the devices 24 and 25 after the end of the previous reservation and before the start of the reservation date and time on the basis of the setting information stored in the storage unit 32 and the reservation information stored in the storage unit 32. According to this, by setting the setting information in the devices 24 and 25 in advance via the operation panel 6, the user can set and prepare the environment of the room 20 according to one's preference by operating the devices 24 and 25 provided in the room 20 to a desired state, without inputting the operation information for operating the devices 24 and 25 via the operation panel 6 each time making a reservation.

(8) The operation management unit 318 stores in the storage unit 32, for each operation panel 6, the required/non-required information on whether or not the devices 26 and 27 are required, which is set in the devices 26 and 27 in advance via the operation panel 6. According to this, the user can manage whether the devices 26 and 27 are required using the dedicated operation panel 6. Further, by inputting the required/non-required information on whether or not the devices are required via the operation panel 6 in advance, the user can set and prepare the environment of the room 20 according to one's preference by setting the required/non-required of the devices 26 and 27 provided in the room 20 to a desired state, without inputting the required/non-required information on whether or not the devices are required via the operation panel 6 each time making a reservation.

### Modification of Embodiments

Note that the present disclosure is not limited to the above embodiment, and modifications, improvements, and the like within a range in which an object of the present disclosure can be achieved are included in the present disclosure.

For example, in the above embodiment, the management server 3 may be configured by a centralized management type server device or may be a distributed management type, for example, a device using a distributed transaction ledger typified by blockchain can be used.

In the above-described embodiment, the device operation unit 311 controls the devices 24 and 25 after the end of the previous reservation and before the start of the reservation date and time on the basis of the operation information for operating the devices 24 and 25, that is input via the operation panel 6, or the setting information stored in the storage unit 32, and the reservation information stored in the storage unit 32.

In contrast, it may be configured such that the authorization unit authorizes the user of the on-demand rental facility to operate the device via the device operation unit after the end of the previous reservation and before the start of the reservation date and time on the basis of the reservation information stored in the storage unit, and when authorized by the authorization unit, the device operation unit controls the device at the reservation date and time on the basis of the operation information for operating the device, that is input via the user input means, and the reservation information stored in the storage unit.

With such a configuration, the authorization unit authorizes the user of the on-demand rental facility to operate the device via the device operation unit after the end of the previous reservation and before the start of the reservation date and time on the basis of the reservation information stored in the storage unit, so that the user can operate the device provided in the on-demand rental facility by the user input means before the start of the reservation date and time. Therefore, the user can set and prepare the environment of the on-demand rental facility according to one's preference, for example, by operating the air conditioner or the like before the start of the reservation date and time.

In the above-described embodiment, when the optical code displayed on the display means 28 is read by the terminal device 4, when the locking device 22 of the room 20 is unlocked by the unlocking key issued by the unlocking key issuing unit 315, and when the authentication code issued by the identification information issuing unit 317 is received via the operation panel 6 at the reservation date and time, the authorization unit 313 authorizes the user of the room 20 to operate the devices 24 and 25 at the reservation date and time via the operation panel 6.

In contrast, when the user's biometric information registered in advance in the management server, identification (ID) registered in advance in the user's terminal device, or the like is received at the reservation date and time, the authorization unit may authorize the user of the on-demand rental facility to operate the devices at the reservation date and time via the device operation unit. In short, the authorization unit only needs to be able to authorize the user of the on-demand rental facility to operate the devices at the reservation date and time via the device operation unit.

In the above embodiment, the management server 3 includes the operation management unit 318 that associates the user of the room 20 with the operation panel 6 to make the user information, and stores and manages the user information in the storage unit 32, but may not include this function.

In the above embodiment, the management server 3 includes the authorization unit 313, which authorizes the user of the room 20 to operate the devices 24 and 25 at the reservation date and time via the device operation unit 311 on the basis of the reservation information stored in the storage unit 32, so that the user can operate the devices 24 and 25 provided in the room 20 by the terminal device 4.

In contrast, in the present disclosure, the management server may not include the authorization unit, and the user may not be able to operate the devices provided in the time rental facility by the user input means.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

What is claimed is:

1. An on-demand rental facility management system comprising:
an on-demand rental facility; and
a management server that manages the on-demand rental facility and is connected via a communication line to both user input means that receives information input by a user of the on-demand rental facility and a device provided in the on-demand rental facility, wherein
the management server comprises:
a device operation unit for allowing the user to operate the device via the user input means; and
a reservation receiving unit for storing reservation information on the user and reservation date and time of the on-demand rental facility in a storage unit by receiving a reservation for the on-demand rental facility via the user input means, and
the device operation unit controls the device after end of previous reservation and before start of the reservation date and time on the basis of operation information for operating the device, that is input via the user input means, and the reservation information stored in the storage unit.

2. The on-demand rental facility management system according to claim 1, wherein
the management server comprises an operation management unit that associates the user of the on-demand rental facility with the device operation unit to make user information, and stores and manages the user information in the storage unit, and stores setting information set in the device in advance via the device operation unit in the storage unit for each device operation unit, and
the device operation unit operates the device after the end of the previous reservation and before the start of the reservation date and time on the basis of the setting information stored in the storage unit and the reservation information stored in the storage unit.

3. The on-demand rental facility management system according to claim 2, wherein the operation management unit stores in the storage unit, for each device operation unit, required/non-required information on whether or not the device is required, which is set in the device in advance via the device operation unit.

4. The on-demand rental facility management system according to claim 1, wherein
the management server comprises an authorization unit for authorizing the user of the on-demand rental facility to operate the device at the reservation date and time via the device operation unit on the basis of the reservation information stored in the storage unit, and
when authorized by the authorization unit, the device operation unit controls the device at the reservation date and time on the basis of the operation information for operating the device, that is input via the user input means, and the reservation information stored in the storage unit.

5. The on-demand rental facility management system according to claim 4, wherein
the on-demand rental facility comprises display means that is provided in the on-demand rental facility and displays information,
the management server comprises a display control unit that causes the display means to switch and display predetermined information for each reservation for the on-demand rental facility, and
when the user input means is caused to read the predetermined information displayed on the display means, the authorization unit authorizes the user of the on-demand rental facility to operate the device at the reservation date and time via the device operation unit.

6. The on-demand rental facility management system according to claim 4, wherein
the on-demand rental facility comprises a locking device that locks and unlocks the on-demand rental facility,
the management server comprises an unlocking key issuing unit that issues an unlocking key for unlocking the locking device of the on-demand rental facility to the user on the basis of the reservation information stored in the storage unit, and
when the locking device of the on-demand rental facility is unlocked by the unlocking key issued by the unlocking key issuing unit, the authorization unit authorizes the user of the on-demand rental facility to operate the device at the reservation date and time via the device operation unit.

7. The on-demand rental facility management system according to claim 4, wherein
the management server comprises an identification information issuing unit that issues predetermined identification information to the user on the basis of the reservation information stored in the storage unit, and
when the identification information issued by the identification information issuing unit is received at the reservation date and time via the user input means, the authorization unit authorizes the user of the on-demand rental facility to operate the device at the reservation date and time via the device operation unit.
